(19) United States
(12) Patent Application Publication
(10) Pub. No.: US 2009/0109793 A1
(43) Pub. Date: Apr. 30, 2009

(54) Juice apparatus and disposable juicer cups

(76) Inventor: Hua J. Xue, Saratoga, CA (US)

Correspondence Address: Bo-In Lin, 13445 Mandoli Drive, Los Altos Hills, CA, 94022, US

(21) Appl. No.: 12/290,279

(22) Filed: Oct. 28, 2008

Related U.S. Application Data
(60) Provisional application No. 61/000,808, filed on Oct. 28, 2007.

(51) Int. Cl. B01F 13/00

(52) U.S. Cl. 366/205

(57) ABSTRACT

A blender apparatus includes a disposable cup. The disposable cup has a set of blending blades disposed on a bottom portion of the disposable cup provided for cutting and blending food chunks contained in the disposable cup. The blender apparatus further includes a base unit. The base unit has a rotating mechanism for engaging the set of blending blades for rotating and cutting and blending the food chunks. The set of blending blades further includes a blade-set engagement interface for engaging to the rotating engagement interface for rotating and cutting and blending the food chunks.

This Application is a Divisional Application and claims a Priority Filing Date of Oct. 28, 2008 benefited from a previously filed Provisional Application 61/000,808 filed previously by the inventor of this Patent Application.

### FIELD OF THE INVENTION

The present invention relates generally to apparatuses and method for producing fruit or vegetable juices. More particularly, this invention is related to apparatuses and methods for providing disposable containers that include integrated blending blades for producing juices such that individual containers are ready to serve to individual customers without requiring a juicer cleaning process after serving each individual customer.

### BACKGROUND OF THE INVENTION

Conventional juicer apparatuses typically include a base unit integrated with a set of blending blades attached to a rotation mechanism for rotating the blades.

Using the conventional juicer apparatuses to produce cups of juice for sales to the public in many popular juice stores now encounters a problem. Customers often have to wait in line for a prolonged period of time before a cup of juice is made available. The waiting time is required due to the fact that after making one cup of juice, the juicer container and the blending blades used once have to be washed. Clean container and blending blades must be used for making next cup of juice for another customer. The wash and clean processes take extra time and delay the process of juice production particularly when there is a long line of customers waiting to be served. In order to serve a next customer, fruits are to be filled into the juicer container before repeating the blending process to produce fruit juice, e.g., smoothie, to pour into a cup to serve another customer. These multiple steps of food processes are time consuming and have a further disadvantage that these processing steps greatly increase the likelihood of food contamination due to the hand contact by the store staffs in carrying out these food processing steps.

Therefore, a need still exists in the art of juicing apparatuses and juice production to provide new and improved juice production devices and methods such that the above discussed difficulties and limitation can be resolved.

### SUMMARY OF THE PRESENT INVENTION

It is therefore an aspect of the present invention to provide new and improved juicer devices with structural features to eliminate the washing and cleaning processes after each use such that the above discussed difficulties and limitations can be resolved.

Specifically, it is an aspect of this invention to provide a disposable juice cup integrated with a set of blender blades with an engaging mechanism to engage a rotor disposed on a base unit. The rotor engages to the set of blender bladders to rotate and blending the pieces of fruits or vegetables into juice. The cup integrated with the blender blades are provided as one-time disposable or reusable cup ready to handover to each customer without requiring washing and cleaning of either the juice holding cup or the blades before making another cup of juice for another customer.

Furthermore, it is another aspect of this invention that the time required for preparation of juices are greatly shortened because the processes for cleaning the cup is no longer required by using the disposable blender cups. The opportunities for opening up other types of sales such as drive through, take-home or home-delivery services of formulated fruit-mixes, juices or smoothies can be conveniently provided contained in disposable blender cups as now disclosed in this invention.

It is another aspect of this invention that the availability of disposable blender cup can actually provide better-sanitized fruit or vegetable juices or smoothies. Pre-packed fruit mixes per formula in the disposable blender cup can be provided by use of machines directly from the fruit suppliers. Unnecessary contact with human hands through multiple processes of washing, peeling, blending, etc., can be eliminated. Furthermore, this will drastically improve the efficiency and reduce the costs.

It is another aspect of this invention that all the parts of the disposable blender are manufactured with non-hazardous materials conforming to international food safety standards. The non-hazardous materials may include moldable materials, such as non-hazardous plastic. The moldable non-hazardous plastic materials are moldable, easier for molding and assembling processes and can be produced with automated processes with reduce production costs. The moldable non-hazardous plastic materials can have material hardness and strength to produce effective blender blades suitable for blending fruits and vegetables.

It is another aspect of this invention the disposable blender can be configured as a bottle with the fresh fruits or vegetables are packed at factory and the bottle can be plugged onto regular blender when a consumer of the fruits or vegetables ready to consume the fruit or vegetable juice contained in the bottle. The configurations of the bottle and particularly the plug interface to a regular blender can be standardized such that a standard packaged bottle useful of expediting the food blending process can be provided.

Briefly, in a preferred embodiment, the present invention discloses a blender apparatus that includes a disposable cup. The disposable cup further has a set of blending blades disposed on a bottom portion of the disposable cup provided for cutting and blending food chunks contained in the disposable cup. In an exemplary embodiment, the blender apparatus further includes a base unit. The base unit has a rotating mechanism for engaging the set of blending blades for rotating and cutting and blending the food chunks. In an exemplary embodiment, the set of blending blades further includes a blade-set engagement interface for engaging to the rotating engagement interface for rotating and cutting and blending the food chunks. In an exemplary embodiment, the blender apparatus further includes a collapsible-and-expandable blender assembly provided for collapsing into a straight-stick for conveniently inserting from a top cover into the disposable cup and expanding with stretching out blades inside the disposable cup for rotating and blending food chunks contained therein. In an exemplary embodiment, the disposable cup includes bottom blending assembly includes a rigid cup-bottom supporting the set of blending blades on a rotational shaft extended from the rigid cup-bottom wherein the rotation shaft further is rotational to provide for rotating the blades for cutting and blending food chunks contained in the disposable cup. In an exemplary embodiment, the bottom blending assembly includes a wedge disposed on the bottom surface of the rigid cup-bottom wherein the wedge is linked to the rotational shaft for engaging to a rotor of the blender apparatus provide for rotating the blades for cutting and blending food chunks contained in the disposable cup. In an exemplary embodiment, the blender apparatus further includes a rotating mechanism to engage the collapsible-and-expandable blending blender assembly for rotating and cutting and blending the food chunks. In an exemplary embodiment, the blender apparatus further includes a collapsible-and-expandable blender assembly that has a collapsible-expansion button for controlling and operating the collapsible-and-expandable blender assembly by collapsing into a straight-stick for conveniently inserting from a top cover into the disposable cup and expanding with stretching out blades inside the disposable cup for rotating and blending food chunks contained therein. In an exemplary embodiment, the bottom blending assembly further includes at least two edges wedge disposed on the bottom surface of the rigid cup-bottom for engaging to and securely holding to a fixed position on a base unit of the blender apparatus whereby the disposable cup is not rotating with the set of blender blades in cutting and blending the food chunks.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A to 1F are perspective views of a juice blender apparatus and components that include a collapsible-and-expandable blender assembly for cutting and blending food chunks according to an exemplary embodiment of this invention.

FIG. 2A is a side cross sectional view of a juicer apparatus of this invention.

FIG. 2B is a side cross sectional view of a disposal cup and FIG. 2C is a side cross sectional view of a bottom blending blades disposed at the bottom portion of the disposal cup of FIG. 2B.

FIGS. 2D-1 and 2D-2 are bottom views of the interfacing bottom of the disposal cup for engaging a rotor of the juicer apparatus of FIG. 2A.

FIG. 2E is a disassembled view of the disposable juicer cup of this invention based on the configurations of FIGS. 2A to 2D.

FIG. 3 is a disposable food-blending bottom includes a blender plug-in adapter for plugging into and adapting to the blender blades for blending the fruits or vegetables or other foods contained in the bottle ready for a blending process.

FIGS. 4A to 4C show another exemplary embodiment of the juicer apparatus implemented with a disposable and removable cutter for engaging and adapting to the sealing rings.

### DETAILED DESCRIPTION OF THE INVENTION

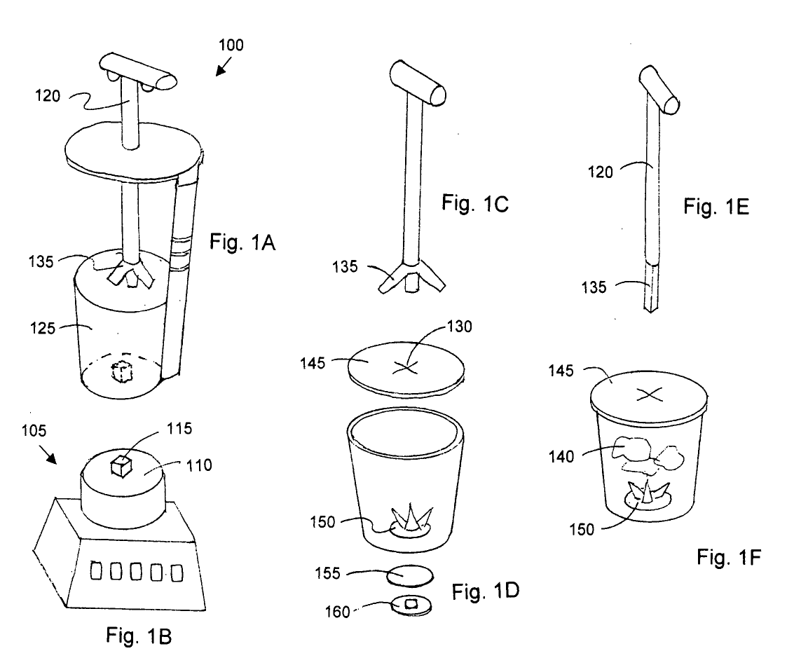

Referring to FIGS. 1A to 1F for perspective views of a blender apparatus 100 and the components of the blender apparatus as exemplary embodiments of this invention. The blender apparatus 100 includes a base unit 105 that includes a rotor 110 with a rotation engaging-block 115. The blender apparatus 100 further includes a collapsible-and-expandable blender assembly 120. The collapsible-and-expandable assembly 120 is inserted into a cup 125 through a top-surface opening 130 with a set of cutting blades 135 expanded inside the cup 125. The collapse and expandable blender assembly 120 is also engaged to a rotating mechanism (not specifically shown). The collapsible-and-expandable blender assembly 120 rotates with the rotating mechanism for cutting and blending chunks of fruits, vegetables, or other food items 140. The chunks of fruits, vegetables, or other food items are filled into the cup 125 by lifting and opening the cup cover 145. The cup 125 further includes a set of cutting blades 150 disposed at the bottom of the cup 140. The set of cutting blades 150 is tightly sealed at the bottom of the cup by a sealing ring 155 and further includes an universal interface bottom 160 with at least an engaging wedges 160 to engage the rotation engaging block 115. The rotor 115 engages to the set of cutting blades 150 to rotate for cutting and blending the fruit or vegetable chunks 140.

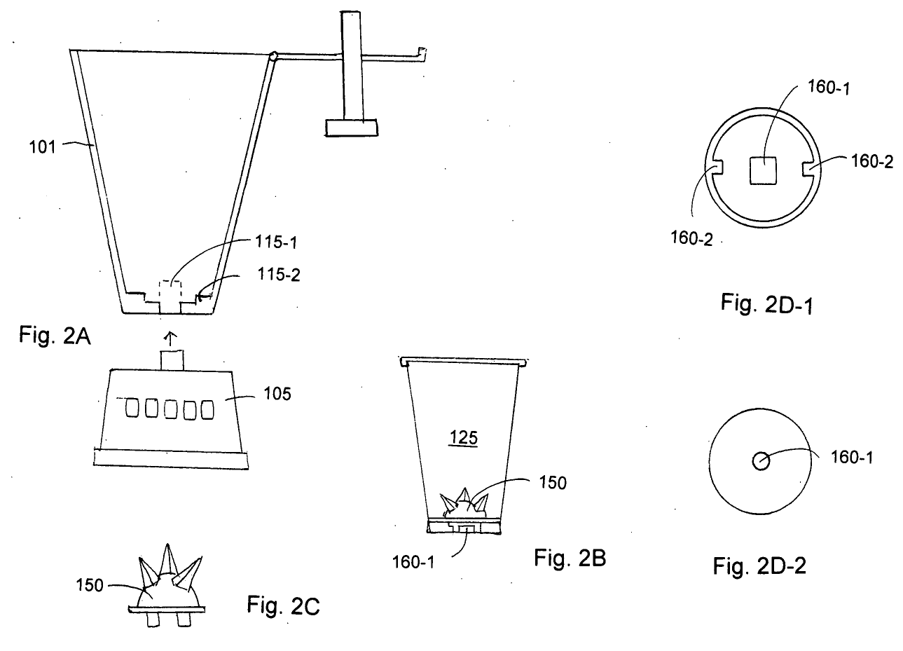

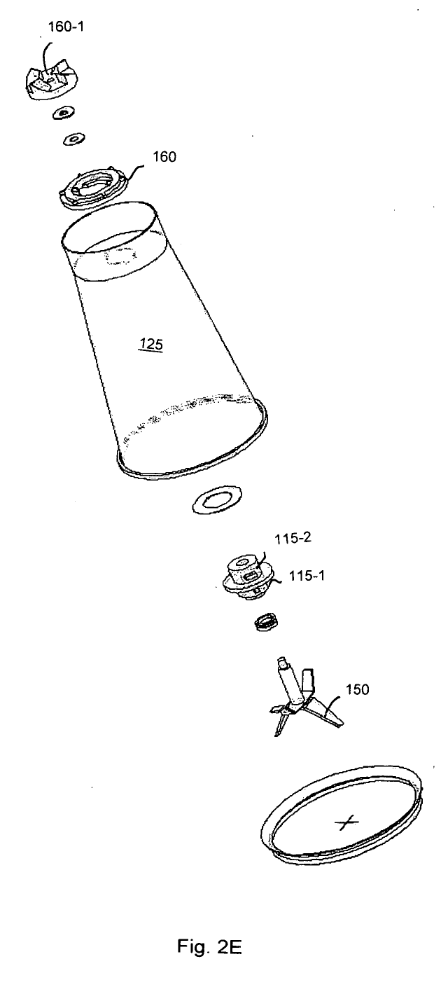

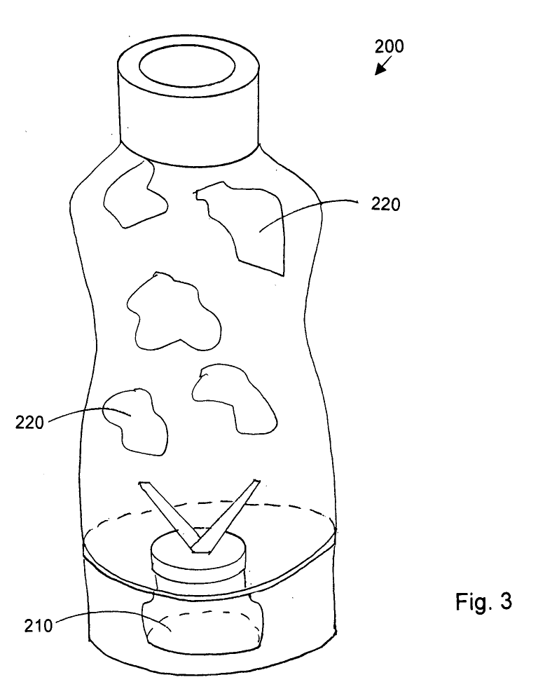

The collapsible-and-expandable blender assembly 120 is collapsible as shown in FIG. 2E to insert into the cup 125 through a top lid opening 130. After inserting into the cup 125 through the top lid opening 130, the collapsible-and-expandable blender assembly 120 is expanded as shown in FIG. 2C with the blades 135 extended and ready to rotate for cutting and blending the fruits, vegetable or other food chunks 140. A control mechanism (not shown) is provided in the collapsible-and-expandable blender assembly 120 to either collapse or expand the blades 135 during the process of collapsing the assembly and inserting the assembly 120 into the cup followed by expanding and extending the blades for cutting and blending operations inside the cup. Finally, the assembly 120 is collapsed again to withdraw from the cup after the cutting and blending operations are completed.

FIG. 2A is a cross sectional view to more specifically illustrate and describe an exemplary embodiment of the juicer apparatus of this invention. FIG. 2A shows a side cross sectional view of the juicer apparatus 100 further includes a universal cup holder 101. The universal cup holder 101 further includes a central engaging block 115-1 and two edge engaging wedges 115-2 to engage the central and edge engaging holes 160-1 and 160-2 at the bottom of the disposal cup 125 as shown in FIGS. 2B and 2D-1 and 2D-2. The central engaging hole 160-1 is further provided to engage the bottom cutting and blending blades 150 to the rotor 110 disposed in the base unit 105 of the juicer apparatus 100. The rotor 110 is engaged to the bottom cutting and blending blades 150 to rotate and process the food chunks inside the disposal cup 125. In the meantime, the edge wedges 115-2 engage to the bottom side-engaging holes 160-2 to rotate together with the rotor 110.

All the parts of the disposable blender as described above are manufactured with non-hazardous materials conforming to international food safety standards. The non-hazardous materials may include moldable materials, such as non-hazardous plastic. The moldable non-hazardous plastic materials are moldable, easier for molding and assembling processes and can be produced with automated processes with reduce production costs. The moldable non-hazardous plastic materials can have material hardness and strength to produce effective blender blades suitable for blending fruits and vegetables.

FIG. 3 shows a disposable food-blending bottle 200. The bottle includes a blender plug-in adapter 210 disposed on the bottom of the bottle for plugging into and adapting to the blender blades 240 for blending the fruits or vegetables 220 or other foods contained in the bottle ready for a blending process. The blender plug-in adapter 210 may be flexibly arranged for conveniently plugging into and adapting to a blender blades to blend and process the fruits, vegetables, or other foods 220. Therefore, this invention further discloses a disposable bottle for containing fruits, vegetables and/or other foods therein. The disposable bottle further includes a blender plug-in and interfacing adapter to plug in and adapt to a blender for blending and processing the fruits, vegetables and/or other foods contained in the disposable bottle. The blender plug-in and interface adapter is standardized for application with different types of blenders. The blender plug-in and interface adapter may be formed in different types of sealed containers such as cups, cans, or different shapes of bottles to broaden the usefulness and application of the blenders for blending and processing the foods contained in the sealed containers.

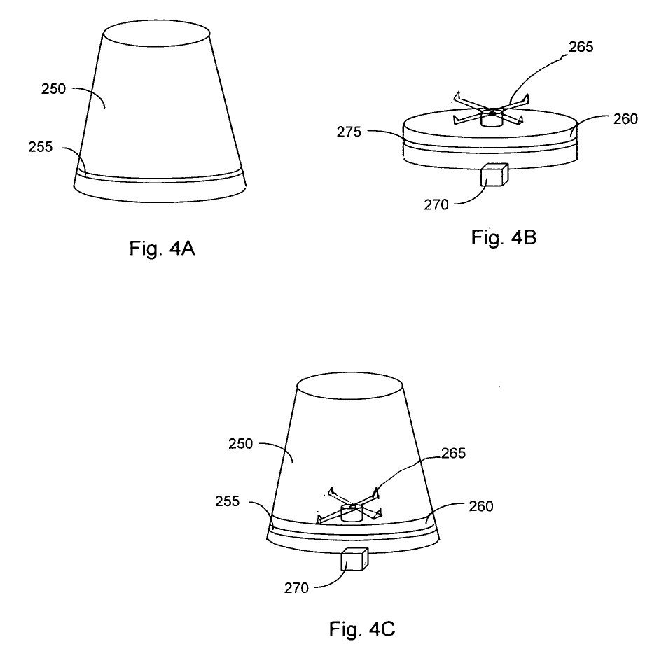

Referring to FIGS. 4A to 4C for another exemplary embodiment of this invention of another juicer apparatus that includes a cup 250 that has anti-leak sealing ridges, e.g., sealing rings 255, for flexibly adapting to a cup cover with sealer to seal the cup to prevent the liquid from leak. The juicer apparatus further includes an adaptable and removable cutter 260 that includes rotational cutting blades 265 and a rotational adaptor 270 extended downwardly from the adaptable cutter 260 for engaging to a blender base unit (not shown) to drive and rotate the cutting blades 265. The adaptable cutter 260 further including a sealer ridge or a sealing ring 275 for adapting into the anti-leak sealing ridges as shown in FIG. 4C to seal the cup 250. The adapter cutter 260 is removable from the cup 250 by using a cup-cover to cover seal and cover the cup. The cutter 260 that may be implemented as a disposable cutter is therefore removed from the cup 250 when serving the drinks such that there is no metal cutter kept in the serving cup.

According to above descriptions, this invention further discloses a method for applying a blender apparatus for cutting and blending food chunks. The method includes a step of disposing a set of blending blades on a bottom portion of a disposable cup for cutting and blending the food chunks contained in the disposable cup. In an exemplary embodiment, the method further includes a step of engaging a rotating mechanism to the set of blending blades for rotating the set of blending blades for cutting and blending the food chunks. In another exemplary embodiment, the step of engaging the set of blending blades to the rotating mechanism further including a step of engaging a blade-set engagement interface to a rotating engagement interface disposed on a base unit of a blender apparatus for rotating, cutting and blending the food chunks. In another exemplary embodiment, the method further includes a step collapsing a collapsible-and-expandable blender assembly into a straight-stick assembly for inserting from a top cover of the disposable cup and expanding with the collapsible-and-expandable blender assembly with stretching out blades inside the disposable cup for rotating and blending food chunks contained therein. In another exemplary embodiment, the step of disposing a set of blending blades on a bottom portion of a disposable cup further including a step of disposing a rigid cup-bottom supporting the set of blending blades on a rotational shaft extended from the rigid cup-bottom wherein the rotation shaft further is rotational to provide for rotating the blades for cutting and blending food chunks contained in the disposable cup. In another exemplary embodiment, the step of disposing a set of blending blades on a bottom portion of a disposable cup further including a step of disposing a wedge on the bottom surface of the rigid cup-bottom and linking the wedge to the rotational shaft for engaging to a rotor of the blender apparatus for rotating the blades for cutting and blending food chunks contained in the disposable cup. In another exemplary embodiment, the method further includes a collapsing a collapsible-and-expandable blender assembly into a straight-stick for conveniently inserting from a top cover into the disposable cup then expanding the collapsible-and-expandable blender assembly with stretching out blades inside the disposable cup for rotating and blending food chunks contained therein. The method further includes a step of engaging the collapsible-and-expandable blender assembly to a rotating mechanism for rotating and cutting and blending the food chunks. In another exemplary embodiment, the method further includes a disposing a collapse-expansion button on a top portion of the collapsible-and-expandable blender assembly for controlling and operating the collapsible-and-expandable blender assembly by pushing the collapse-expansion button to alternately collapse and expand the collapsible-and-expandable blender assembly. In another exemplary embodiment, the step of disposing a rigid cup-bottom further includes a step of forming at least two edges wedge on the bottom surface of the rigid cup-bottom for engaging to and securely holding to a fixed position on a base unit of the blender apparatus whereby the disposable cup is not rotating with the set of blender blades in cutting and blending the food chunks.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A blender apparatus comprising:
a disposable cup including a set of blending blades disposed on a bottom portion of said disposable cup provided for cutting and blending food chunks contained in said disposable cup.

2. The blender apparatus of claim 1 further comprising:
a base unit including a rotating mechanism for engaging said set of blending blades for rotating and cutting and blending said food chunks.

3. The blender apparatus of claim 1 further comprising:
a base unit including a rotating mechanism having an rotating engagement interface; and
said set of blending blades further including a blade-set engagement interface for engaging to said rotating engagement interface for rotating and cutting and blending said food chunks.

4. The blender apparatus of claim 1 further comprising: a collapsible-and-expandable blender assembly provided for collapsing into a straight-stick for conveniently inserting from a top cover into said disposable cup and expanding with stretching out blades inside said disposable cup for rotating and blending food chunks contained therein.

5. The blender apparatus of claim 1 wherein:
said disposable cup including bottom blending assembly including a rigid cup-bottom supporting said set of blending blades on a rotational shaft extended from said rigid cup-bottom wherein said rotation shaft further is rotational to provide for rotating said blades for cutting and blending food chunks contained in said disposable cup.

6. The blender apparatus of claim 5 wherein:
said bottom blending assembly including a wedge disposed on the bottom surface of said rigid cup-bottom wherein said wedge is linked to said rotational shaft for engaging to a rotor of said blender apparatus provide for rotating said blades for cutting and blending food chunks contained in said disposable cup.

7. The blender apparatus of claim 1 further comprising:
a collapsible-and-expandable blender assembly provided for collapsing into a straight-stick for conveniently inserting from a top cover into said disposable cup and expanding with stretching out blades inside said disposable cup for rotating and blending food chunks contained therein; and
a rotating mechanism for engaging to said collapsible-and-expandable blending blender assembly for rotating and cutting and blending said food chunks.

8. The blender apparatus of claim 1 further comprising:
a collapsible-and-expandable blender assembly having a collapse-expansion button for controlling and operating said collapsible-and-expandable blender assembly by collapsing into a straight-stick for conveniently inserting from a top cover into said disposable cup and expanding with stretching out blades inside said disposable cup for rotating and blending food chunks contained therein.

9. The blender apparatus of claim 5 wherein:
said bottom blending assembly further including at least two edges wedge disposed on the bottom surface of said rigid cup-bottom for engaging to and securely holding to a fixed position on a base unit of said blender apparatus whereby said disposable cup is not rotating with said set of blender blades in cutting and blending said food chunks.

10. A disposable cup comprising:
a bottom blending assembly including a rigid cup-bottom supporting a set of blending blades on a rotational shaft extended from said rigid cup-bottom for engaging and rotating with a rotation mechanism of a blender apparatus.

11. The disposable cup of claim 10 wherein:
said bottom blending assembly including a wedge disposed on the bottom surface of said rigid cup-bottom wherein said wedge is linked to said rotational shaft for engaging to a rotor of said blender apparatus provide for rotating said blades for cutting and blending food chunks contained in said disposable cup.

12. A method for applying a blender apparatus for cutting and blending food chunks comprising:
disposing a set of blending blades on a bottom portion of a disposable cup for cutting and blending said food chunks contained in said disposable cup.

13. The method of claim 12 further comprising:
engaging a rotating mechanism to said set of blending blades for rotating said set of blending blades for cutting and blending said food chunks.

14. The method of claim 13 wherein:
said step of engaging said set of blending blades to said rotating mechanism further including a step of engaging a blade-set engagement interface to a rotating engagement interface disposed on a base unit of a blender apparatus for rotating, cutting and blending said food chunks.

15. The method of claim 12 further comprising:
collapsing a collapsible-and-expandable blender assembly into a straight-stick assembly for inserting from a top cover of said disposable cup and expanding with said collapsible-and-expandable blender assembly with stretching out blades inside said disposable cup for rotating and blending food chunks contained therein.

16. The method of claim 12 wherein:
said step of disposing a set of blending blades on a bottom portion of a disposable cup further including a step of disposing a rigid cup-bottom supporting said set of blending blades on a rotational shaft extended from said rigid cup-bottom wherein said rotation shaft further is rotational to provide for rotating said blades for cutting and blending food chunks contained in said disposable cup.

17. The method of claim 16 wherein:
said step of disposing a set of blending blades on a bottom portion of a disposable cup further including a step of disposing a wedge on the bottom surface of said rigid cup-bottom and linking said wedge to said rotational shaft for engaging to a rotor of said blender apparatus for rotating said blades for cutting and blending food chunks contained in said disposable cup.

18. The method of claim 12 further comprising:
collapsing a collapsible-and-expandable blender assembly into a straight-stick for conveniently inserting from a top cover into said disposable cup then expanding said collapsible-and-expandable blender assembly with stretching out blades inside said disposable cup for rotating and blending food chunks contained therein.
engaging said collapsible-and-expandable blender assembly to a rotating mechanism for rotating and cutting and blending said food chunks.

19. The method of claim 18 further comprising:
disposing a collapse-expansion button on a top portion of said collapsible-and-expandable blender assembly for controlling and operating said collapsible-and-expandable blender assembly by pushing said collapse-expansion button to alternately collapse and expand said collapsible-and-expandable blender assembly.

20. The method of claim 16 wherein:
said step of disposing a rigid cup-bottom further includes a step of forming at least two edges wedge on the bottom surface of said rigid cup-bottom for engaging to and securely holding to a fixed position on a base unit of said blender apparatus whereby said disposable cup is not rotating with said set of blender blades in cutting and blending said food chunks.
